(19) United States
(12) Patent Application Publication
(10) Pub. No.: US 2005/0132803 A1
(43) Pub. Date: Jun. 23, 2005

(54) Low cost integrated MEMS hybrid

(76) Inventors: David J. Baldwin, Allen, TX (US); Eric C. Blackall, Dallas, TX (US); Ross E. Teggatz, McKinney, TX (US)

Correspondence Address: TEXAS INSTRUMENTS INCORPORATED, P O BOX 655474, M/S 3999, DALLAS, TX, 75265, US

(21) Appl. No.: 10/811,101

(22) Filed: Mar. 26, 2004

Related U.S. Application Data
(60) Provisional application No. 60/532,313, filed on Dec. 23, 2003.

(51) Int. Cl. G01P 15/125

(52) U.S. Cl. 73/514.32

(57) ABSTRACT

The present invention is directed to MEMS-based accelerometer comprising semiconductor substrate and a generally hollow shell having an open end and a closed end, wherein the open end of the shell is generally bonded to the top surface of the substrate. The shell comprises a plurality of capacitor plates electrically connected to a respective plurality of capacitor electrodes associated with the shell, wherein the shell further comprises a common electrode, and wherein the plurality of capacitor electrodes and the common electrode are electrically connected to the substrate via the bonding of the open end of the shell to the substrate. The accelerometer further comprises a sensing element comprising an electrically conductive torsion bar coupled to the shell, defining an axis of rotation. A proof mass and a plurality of electrically conductive paddles are coupled to the torsion bar, wherein a movement of the proof mass is operable to cause a rotation of the paddles about the axis of rotation, therein changing a capacitance between the plurality of paddles and the respective plurality of capacitor plates.

### RELATED APPLICATIONS

This application claims the priority of U.S. Provisional Application Ser. No. 60/532,313, filed Dec. 23, 2003, entitled LOW COST INTEGRATED MEMS HYBRID.

### FIELD OF THE INVENTION

The present invention relates generally to the field of integrated circuit processing, and more particularly relates to a MEMS-based accelerometer.

### BACKGROUND OF THE INVENTION

In many industries, accelerometers are useful devices that are used to sense an externally-induced acceleration on a body. Typically, an accelerometer comprises a sensing element that is operable to move in response to an applied acceleration, and a displacement transducer that measures the amount of movement of the sensing element. The sensing element, for example, is typically referred to as a proof mass or seismic mass. The proof mass is typically held in its resting position by a spring. The displacement transducer, for example, is used to measure the amount of motion of the proof mass in response to the applied acceleration. The measured motion, for example, can be converted into an electrical output signal and may, for example, include signal conditioning electronics to provide a strengthened signal for accurate measurement of the displacement. The output signal from signal conditioning electronics may then be used by additional electronic control circuitry to determine how to respond to the detected acceleration.

Numerous applications exist for accelerometers, such as in automotive applications where accelerometers are utilized for airbag deployment, active suspension, anti-lock braking, and active steering. Solid-state accelerometers based on a piezoelectric effect have been implemented in an attempt to meet the performance requirements of these applications, however, conventional piezoelectric accelerometers are typically expensive and/or physically too large to be practical for implementation in many modern applications.

Micro-electro-mechanical systems (MEMS) have introduced another approach to accelerometers. MEMS technology utilizes microelectronic processing techniques in order to reduce typical mechanical components of an accelerometer to the scale of microelectronics. MEMS technology offers the opportunity for integrating mechanical sensor elements and their associated signal processing electronics onto a single chip in a common manufacturing process. This integrated approach contrasts the separate manufacturing processes and facilities that are typically utilized to fabricate separate mechanical components and electronic components for the accelerometers. In the past, individual mechanical and electronic components of the accelerometer were typically assembled together in a final package, thus resulting in manufacturing complexity and an increased cost of the final product. Consequently, MEMS offers the potential for substantial reductions in size and weight, as well as improvements in cost, performance, and reliability when compared to past technology.

The formation of an exemplary conventional MEMS accelerometer generally comprises forming a moveable structure or sense element (e.g., a cantilevered beam) on a first wafer and subsequently bonding the first wafer to a second wafer having control circuitry for the accelerometer. The second wafer generally comprises one or more capacitor plates, wherein the one or more capacitor plates are separated from the sense element, and wherein the sense element is electrically connected via wire bonding to the second wafer. Such a configuration generally provides one or more variable capacitors, wherein a change in capacitance due to a movement of the moveable structure is utilized to determine an acceleration of the accelerometer.

Such a conventional micro-machined accelerometer, however, has several drawbacks. Generally, the two wafers must be bonded together, wherein a distance between the one or more capacitor plates and the sense element can vary from device to device. Therefore, more circuitry is generally needed in order to “zero” each accelerometer to determine a base capacitance for each. Further, such an accelerometer typically involves wire bonding of the first substrate sense element to the second substrate electronics, thus taking up valuable wafer real estate, as well as increasing manufacturing steps in forming the completed circuit.

Therefore, it would be highly desirable to fabricate an accelerometer having a sense element and capacitor plates on the same wafer, wherein the wafer can be electrically connected to another wafer without the need for wire bonding. Furthermore, such an accelerometer should be compact and sensitive to an applied acceleration.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

The present invention is generally directed to a MEMS-based accelerometer that comprises a sense element and capacitor plates on a common structure. According to one exemplary aspect of the invention, the accelerometer is bonded using flip-chip techniques to a generally planar semiconductor substrate. The accelerometer, for example, comprises a generally hollow shell having an open end and a closed end, wherein a cavity is generally defined within the shell. According to one example, the open end of the shell is bonded to a top surface of the semiconductor substrate, wherein the closed end of the shell is generally parallel to the top surface of the substrate.

According to another exemplary aspect, the closed end of the shell comprises a plurality of capacitor plates electrically connected to a respective plurality of capacitor electrodes associated with the shell. The shell further comprises a common electrode, and wherein the plurality of capacitor electrodes and the common electrode are electrically connected to the substrate via the bonding of the open end of the shell to the substrate. The accelerometer, for example, further comprises an elongate electrically conductive torsion bar, an elongate proof mass coupled to the torsion bar, and a plurality of electrically conductive paddles coupled to the torsion bar and the proof mass. Ends of the torsion bar are coupled to the shell within the cavity of the shell, wherein the torsion bar generally defines an axis of rotation of the torsion bar, proof mass, and plurality of paddles.

According to another exemplary aspect of the invention, the plurality of paddles extend generally parallel to the top surface of the substrate and outwardly from the axis of rotation. For example, the plurality of paddles are generally symmetric to one another about the axis of rotation. The torsion bar and plurality of paddles are further electrically connected to the common electrode of the shell, and each of the plurality of paddles is suspended by the torsion bar from a respective one or the plurality of capacitor plates by a predetermined first distance, therein defining a respective plurality of capacitors.

The plurality of capacitors are operable to determine an acceleration of the accelerometer, such that a movement of the proof mass is operable to cause a rotation of the paddles about the axis of rotation. The rotation thus causes a change in capacitance between the plurality of paddles and the respective plurality of capacitor plates, and such change in capacitance can be further utilized by other circuitry to provide a measured change in acceleration of the accelerometer.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a partial cross-sectional view of a MEMS-based accelerometer prior to connecting to a substrate according to one exemplary aspect of the present invention.

FIG. 2 is a partial cross-sectional view of an exemplary MEMS-based accelerometer connected to a substrate in operation according to yet another exemplary aspect of the present invention.

FIG. 3 is a partial cross-sectional view of an exemplary MEMS-based accelerometer showing an electrical connection pathway according to another exemplary aspect of the present invention.

FIG. 4 is a plan view of the MEMS-based accelerometer of FIG. 3 according to another exemplary aspect of the invention.

### DETAILED DESCRIPTION OF THE INVENTION

The present invention is directed towards micro-electro-mechanical system (MEMS) device associated with a semiconductor substrate. In particular, the device comprises an accelerometer that is operable to sense an acceleration of the device and associated substrate, wherein the device can be integrated into an integrated circuit in a cost-effective manner. Accordingly, the present invention will now be described with reference to the drawings, wherein like reference numerals are used to refer to like elements throughout. It should be understood that the description of these aspects are merely illustrative and that they should not be taken in a limiting sense. In the following description, for purposes of explanation, numerous specific details are set forth in order to provide a thorough understanding of the present invention. It will be evident to one skilled in the art, however, that the present invention may be practiced without these specific details.

According to one exemplary aspect of the present invention, a MEMS-based generally hollow shell is formed such that the shell comprises a sense element, such as a cantilevered beam, and a plurality of capacitor plates formed on a single substrate such as a semiconductor substrate. The shell can subsequently be bonded to another substrate having other integrated circuits formed thereon to form an integrated accelerometer device, wherein the shell, for example, is electrically connected to the other substrate using flip chip technology.

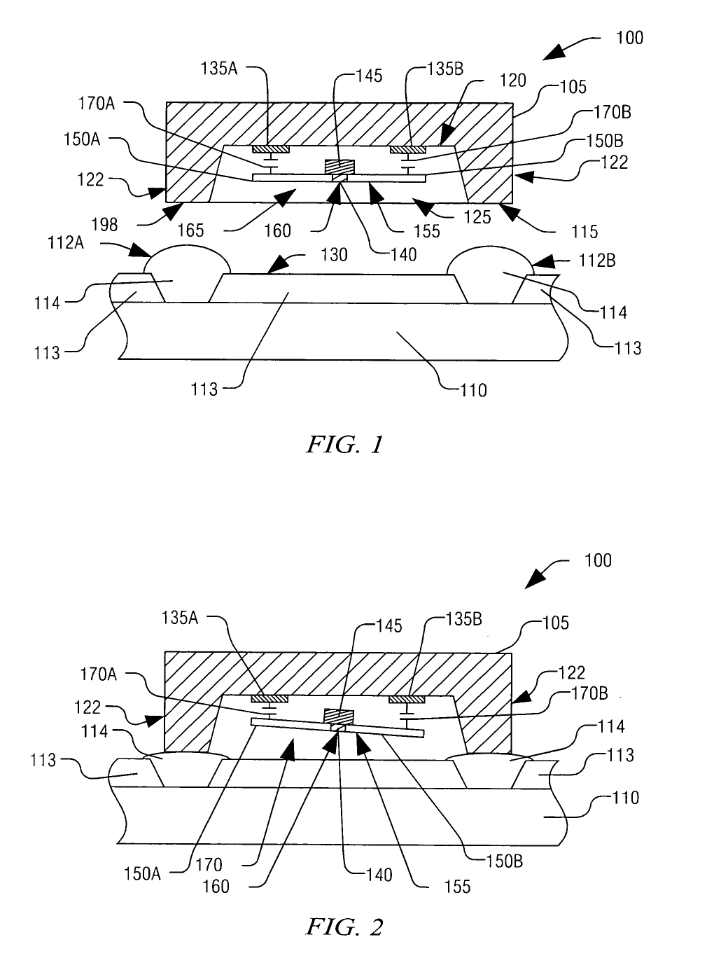

Referring now to the figures, FIG. 1 illustrates an exemplary MEMS-based accelerometer 100 in a state prior to bonding the shell 105 of the accelerometer to a semiconductor substrate 110. The substrate 110, for example, is generally planar, and comprises a plurality of contact regions 112A and 112B separated by a insulative regions 113. The insulative regions, for example, may comprise a nitride or other electrically insulative layer. In one example, a plurality of solder balls or a conductive epoxy 114 are associated with each of the respective plurality of contact regions 112A and 112B and the shell 105, wherein the solder balls are operable to form a plurality of electrical contacts between the substrate 110 and the shell, as will be discussed infra.

According to one exemplary aspect of the invention, the shell 105 comprises an open end 115, a closed end 120, and one or more sidewalls 122, therein defining a cavity 125 within the shell. The open end 115 of the shell 105, for example, is generally bonded to a top surface 130 of the substrate 110, as illustrated in FIG. 2. For example, the plurality of solder balls 114 generally seal a portion (not shown) of the shell 105 to the substrate 110, as will be further discussed infra. The closed end 120 of the shell 105, for example, is generally parallel to the top surface 130 of the substrate 110, wherein the closed end further comprises a plurality of capacitor plates 135A and 135B. The plurality of capacitor plates 135A and 135B are electrically connected to a respective plurality of capacitor electrodes (not shown) associated with the shell 105, as will be discussed hereafter.

According to another exemplary aspect of the present invention, the accelerometer 100 further comprises an elongate electrically conductive torsion bar 140, wherein ends (not shown) of the torsion bar are coupled to the shell 105 within the cavity 125. For example, the torsion bar 140 (e.g., a patterned layer of polysilicon) is coupled to the one or more sidewalls 122 of the shell 105. The torsion bar 140 is further electrically connected to a common electrode (not shown) associated with the shell 105, as will be further discussed hereafter. According to one example, an elongate proof mass 145 (e.g., a polysilicon mass) and a plurality of electrically conductive paddles 150A and 150B (e.g., formed from the same patterned polysilicon layer as the torsion bar 140) are coupled to the torsion bar 140, wherein the proof mass, paddles, and torsion bar generally define a sensing element 155. The sensing element 155, for example, is operable to sense a movement of the accelerometer 100, wherein the proof mass 145 and paddles 150A and 150B are operable to rotate about an axis of rotation 160, wherein the axis of rotation is generally defined by the torsion bar 140. The torsion bar 140 generally provides an inherent spring for returning the sensing element 155 to a stable sensing position 165, as illustrated in FIG. 1. The sensing element 155 is further electrically connected to a common electrode (not shown) associated with the shell 105, wherein the common electrode is further electrically connected to the substrate via the bonding of the open end 115 of the shell to the substrate 110.

According to another exemplary aspect, the plurality of electrically conductive paddles 150A and 150B are electrically connected to the torsion bar 140, wherein the plurality of paddles extend outwardly from the axis of rotation 160 and generally parallel to the top surface 130 of the substrate 110 when in the stable sensing position 165. In accordance with one example, the plurality of paddles 150A and 150B are generally symmetric to one another about the axis of rotation 160. Each of the plurality of paddles 150A and 150B is generally suspended by the torsion bar 140 from a respective one or the plurality of capacitor plates 135A and 135B by a predetermined first distance, therein defining a respective plurality of capacitors 170A and 170B. Consequently, a movement of the accelerometer 100 is operable to move the proof mass 145, thus causing a rotation of the paddles 150A and 150B about the axis of rotation 160, as illustrated in FIG. 2, therein changing the predetermined distance between the respective capacitor plates 135A and 135B and the paddles 150A and 150B, wherein a measurement of the capacitance between the plurality of paddles and the respective plurality of capacitor plates is associated with the motion of the proof mass.

It should be noted that the accelerometer 100 of the present invention provides several advantages over the prior art. For instance, the present invention maximizes an acceptable product yield by minimizing yield losses typically associated with conventional MEMS-based accelerometers. For example, the shell 105 of the present invention advantageously comprises both the capacitor plates 135A and 135B as well as the plurality of paddles 150A and 150B, wherein the capacitance between the respective capacitor plates and the paddles can be tested prior to the bonding of the shell to the substrate 110. Accordingly, the present invention generally permits a screening of the shells 105 prior to bonding, wherein only shells which provide a capacitance within a predetermined range are selected to be subsequently bonded to the substrate 110. Therefore, the present invention obviates additional electronic conditioning circuitry (not shown) typically utilized on the substrate 110 to accommodate capacitances which fall outside of the predetermined range. Furthermore, according to another example, devices (not shown) to which the shell 105 is electrically connected on the substrate 110 can also be tested prior to the bonding of the shell 105 thereto, wherein the shells are only bonded to properly functioning devices, thus further minimizing product yield losses. The testing of the shell 105 and/or devices (not shown) on the substrate 110, for example, can be performed by a probe or other operation operable to identify properly functioning shells and/or devices prior to the bonding of the shell to the substrate.

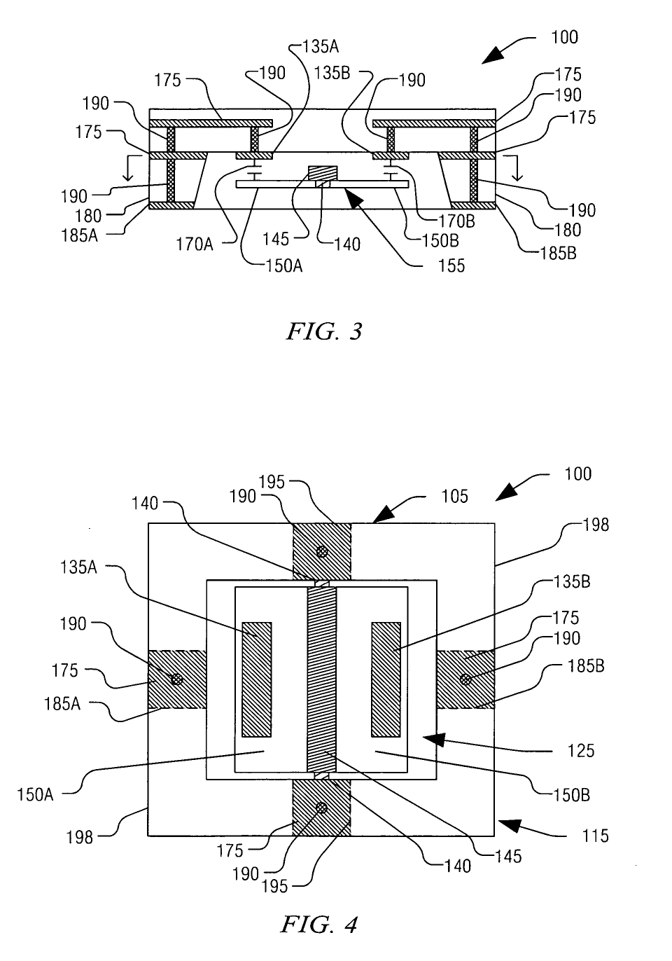

FIG. 3 illustrates a cross-sectional view of the accelerometer 100 according to another exemplary aspect of the present invention, wherein the accelerometer is formed using MEMS technology. According to one example, multiple layers of conductive and non-conductive materials are formed and patterned to define electrical connections to the plurality of capacitor plates 135A and 135B and the sensing element 155. For example, the accelerometer 100 comprises patterned metal layers or patterned electrically conductive polycrystalline silicon layers 175 (e.g., polysilicon or “poly”) separated by electrically insulative layers 180 (e.g., oxide layers), wherein the plurality of capacitors 170A and 170B are formed and are operable to be electrically connected to the substrate (not shown). According to one example, the conductive layers 175 are deposited over the insulative layers 180 at a temperature of approximately 600° C. According to one aspect of the present invention, such high temperature processing is permissible, since the accelerometer is formed on a separate substrate than that of other integrated circuitry. This provides a distinct advantage over conventional accelerometers, wherein such a high temperature can have deleterious effects on the control circuitry if an attempt is made to form the accelerometer on the same substrate as the control circuitry, as will be understood by one of ordinary skill in the art.

FIG. 3 further illustrates a patterning of the conductive layers 175 and insulative layers 180 such that the capacitor plates 135A and 135B are electrically connected to capacitor electrodes 185A and 185B by a plurality of electrically conductive vias 190 which generally pass through the insulative layers 180. FIG. 4 illustrates a plan view of the accelerometer of FIG. 3, and further illustrates the common electrodes 195, wherein the common electrodes are electrically connected to the torsion bar 140 of FIG. 3 in a similar manner to that of the capacitor electrodes.

The formation and patterning of conductive and insulative layers, as well as the formation of the sensing elements and electrodes, for example, is carried out using conventional MEMS fabrication techniques. However, the present invention advantageously forms the capacitor plates 135A and 135B in the same accelerometer package, wherein the predetermined distance separating the capacitor plates from the paddles 150A and 150B can be uniformly maintained independent of variations in the attachment between the shell 105 and the substrate 110. Such an accelerometer provides numerous advantages as compared to conventional accelerometers, wherein the capacitor plates are formed on a separate substrate, and the distance between the sensing element and the capacitor plates can vary significantly, depending on a placement of the sensing element, thereby degrading performance or requiring more complex circuitry for accommodating and/or compensating for such variation.

In accordance with yet another exemplary aspect of the present invention, FIG. 4 illustrates a frit glass 198 which resides on the open end 115 of the shell 105 between the capacitor electrodes 185A and 185B and the common electrodes 195, wherein the frit glass is further utilized to form a hermetic seal between the shell and the substrate 110, as illustrated in FIG. 1. The solder balls 114 and the frit glass 198, for example, can be flowed to connect the accelerometer 100 to the substrate 110 at a substantially low temperature (e.g., approximately 300° C.), wherein circuitry (not shown) residing on the substrate is not significantly affected. According to another example, the common electrode 195 is electrically connected to a common voltage potential associated with the substrate 110, and the capacitor electrodes 185A and 185B are electrically connected to a voltage source, wherein a difference in capacitance between the capacitors 170A and 170B can be measured to determine the movement of the accelerometer. The sealing of the shell 105 to the substrate in the manners described herein advantageously facilitates electrical connection of the MEMS accelerometer to the accompanying circuitry with wire bonds and protects the MEMS components from mold compound, etc., during subsequent fabrication steps and operation.

Although the invention has been shown and described with respect to a certain aspect or various aspects, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.”

1. A MEMS-based accelerometer, comprising:
a generally planar semiconductor substrate having a top surface;
a generally hollow shell having an open end and a closed end, therein defining a cavity within the shell, wherein the open end of the shell is generally bonded to the top surface of the substrate, wherein the closed end of the shell is generally parallel to the top surface of the substrate and comprises a plurality of capacitor plates electrically connected to a respective plurality of capacitor electrodes associated with the shell, wherein the shell further comprises a common electrode, and wherein the plurality of capacitor electrodes and the common electrode are electrically connected to the substrate via the bonding of the open end of the shell to the substrate;
an elongate electrically conductive torsion bar, wherein ends of the torsion bar are coupled to the shell within the cavity, wherein the torsion bar is electrically connected to the common electrode of the shell, and wherein the torsion bar generally defines an axis of rotation;
an elongate proof mass coupled to the torsion bar;
a plurality of electrically conductive paddles coupled to the torsion bar and the proof mass, therein electrically connecting the paddles to the torsion bar, wherein the plurality of paddles extend generally parallel to the top surface of the substrate and outwardly from the axis of rotation and are generally symmetric to one another about the axis of rotation, and wherein each of the plurality of paddles is suspended by the torsion bar from a respective one or the plurality of capacitor plates by a predetermined first distance, therein defining a respective plurality of capacitors, wherein a movement of the proof mass is operable to cause a rotation of the paddles about the axis of rotation, therein changing a capacitance between the plurality of paddles and the respective plurality of capacitor plates.

2. The accelerometer of claim 1, wherein the shell is bonded to the substrate by a plurality of solder balls, wherein the plurality of solder balls electrically connect the shell to the substrate.

3. The accelerometer of claim 2, wherein the plurality of solder balls further generally seal the cavity from an external environment.

4. The accelerometer of claim 2, wherein the plurality of solder balls electrically connect the common electrode and the plurality of capacitor electrodes to a plurality of electrodes associated with the substrate.

5. The accelerometer of claim 3, wherein the common electrode is electrically connected to a common voltage potential associated with the substrate.

6. The accelerometer of claim 2, further comprising a sealing layer of frit glass, wherein the frit glass provides a hermetic seal between the shell and the substrate.

7. A MEMS based accelerometer system, comprising:
a MEMS shell having a cavity therein, the MEMS shell further comprising a capacitive accelerometer arrangement integrated therein; and
a semiconductor substrate having a top surface, wherein the MEMS shell is configured with respect to the substrate such that the cavity faces down toward the top surface of the substrate, and wherein the MEMS shell is bonded to the substrate and electrically coupled thereto through the bonding arrangement, thereby sealing the cavity.

8. The MEMS based accelerometer system of claim 7, wherein the capacitive accelerometer arrangement comprises:
a pair of individually isolated capacitor plates overlying a bottom portion of the cavity;
a torsion bar coupled to the shell and spanning a portion of the cavity, wherein the torsion bar defines an axis of rotation;
a proof mass coupled to the torsion bar; and
a pair of electrically conductive paddles coupled to the torsion bar and extending generally parallel to the pair of capacitor plates, respectively, and defining a spacing therebetween, wherein the capacitor plates and conductive paddles define a pair of accelerometer capacitors.

9. The MEMS based accelerometer system of claim 8, wherein the spacing between the capacitor plates and the conductive paddles, respectively, is substantially equal when an acceleration on the system is substantially zero.

10. The MEMS based accelerometer system of claim 7, wherein the MEMS shell further comprises conductive regions at an interface portion thereof and electrical connections between the elements of the capacitive accelerometer arrangement and the conductive regions.

11. The MEMS based accelerometer system of claim 10, wherein the conductive regions are electrically isolated from one another and make selective electrical contact to circuitry associated with the semiconductor substrate.

12. The MEMS based accelerometer system of claim 11, wherein the selective electrical contact comprises solder balls that are flowed under heating conditions to establish an electrical connection.

13. The MEMS based accelerometer system of claim 11, wherein regions between the MEMS shell and the semiconductor substrate not associated with the conductive regions have insulative material thereon to facilitate the sealing of the cavity and electrical isolation of the electrical connections.

14. The MEMS based accelerometer system of claim 13, wherein the insulative material comprises frit glass.

15. The MEMS based accelerometer system of claim 14, wherein the frit glass comprises flowed frit glass formed under heating conditions, wherein the flowed frit glass generally hermetically seals the cavity.
